(19) United States
(12) Patent Application Publication
(10) Pub. No.: US 2021/0304110 A1
(43) Pub. Date: Sep. 30, 2021

(54) CAPABILITY MATCHING ASSIST APPARATUS

(71) Applicant: Honda Motor Co., Ltd., Tokyo (JP)

(72) Inventors: Daisuke Sawai, Wako-shi (JP); Jun Kudo, Wako-shi (JP); Midori Kumakura, Tokyo (JP); Taichiro Sato, Wako-shi (JP); Ryo Nakayama, Wako-shi (JP)

(21) Appl. No.: 17/194,896

(22) Filed: Mar. 8, 2021

(30) Foreign Application Priority Data
Mar. 30, 2020 (JP) 2020-059598

(51) Int. Cl. G06Q 10/06

(52) U.S. Cl. CPC G06Q 10/063112

(57) ABSTRACT

A capability matching assist apparatus configured to assist matching of capability between a first user(s) who can provide capability and a second user(s) who needs capability. The apparatus has a computer configured to function to register at least one of human capability of the first user and machine capability of machinery owned by the first user, to register at least one of human capability and machine capability needed by the second user, and to collate registered contents and discriminate based on collation results whether the second user can be benefited by providing the capability of the first user.

### CROSS-REFERENCE TO RELATED APPLICATIONS

This invention is based upon and claims the benefit of priority from Japanese Patent Application No. 2020-059598 filed on Mar. 30, 2020, the contents of which are incorporated herein by reference.

### BACKGROUND OF THE INVENTION

### Field of the Invention

This invention relates to a capability matching assist apparatus, particularly to a capability matching assist apparatus for helping to match capabilities between first user who can provide capabilities and second user who need capabilities.

When lifelines are damaged or otherwise impacted at the time of an emergency triggered by a natural disaster or other such event, matching of a person(s) providing capability (herein called a first user) with a person(s) needing capability (herein called a second user) should preferably be assisted in a suitable manner. The technology set out in Japanese Unexamined Patent Publication No. 2001-350991 (JP2001-350991A) is known as a matching assist technology.

However, owing to the fact that the technology described in the reference is focused exclusively on matching between recruiters and job-seekers, a need has been felt for a technology for appropriately assisting capability matching between a person(s) who can provide capability(ies) and a person(s) who needs capability(ies) in situations where lifelines are damaged or otherwise impacted at time of an emergency of the kind mentioned above.

### SUMMARY OF THE INVENTION

Therefore, this invention is aimed at addressing the aforesaid problem by providing a capability matching assist apparatus configured to suitably assist capability matching between a person(s) who can provide capability(ies) and a person(s) who need capability(ies).

In order to achieve the object, this invention provides a capability matching assist apparatus configured to assist matching of capability between at least one first user who can provide capability and at least one second user who needs capability, comprising: a computer equipped with at least one processor and at least one memory coupled to the processor, wherein the processor is configured to perform as a first user registration unit configured to register at least one of human capability of the first user and machine capability of machinery owned by the first user; a second user registration unit configured to register at least one of human capability and machine capability needed by the second user; and a discrimination unit configured to collate registered contents of the first user registration unit and second user registration unit and discriminate based on collation results whether the second user can be benefited by providing the capability of the first user.

### BRIEF DESCRIPTION OF THE DRAWINGS

The above and other objects and advantages will be more apparent from the following description and drawings, in which:

FIG. 1 is a conceptual diagram showing an overview of a capability matching assist apparatus according to an embodiment of this invention;

FIG. 2 is an explanatory diagram detailing the configuration of a computer of FIG. 1; and

FIG. 3 is a flowchart showing functions performed by the processor of the computer of FIG. 1.

### DETAILED DESCRIPTION OF THE INVENTION

A capability matching assist apparatus according to an embodiment of this invention is explained with reference to the attached drawings in the following.

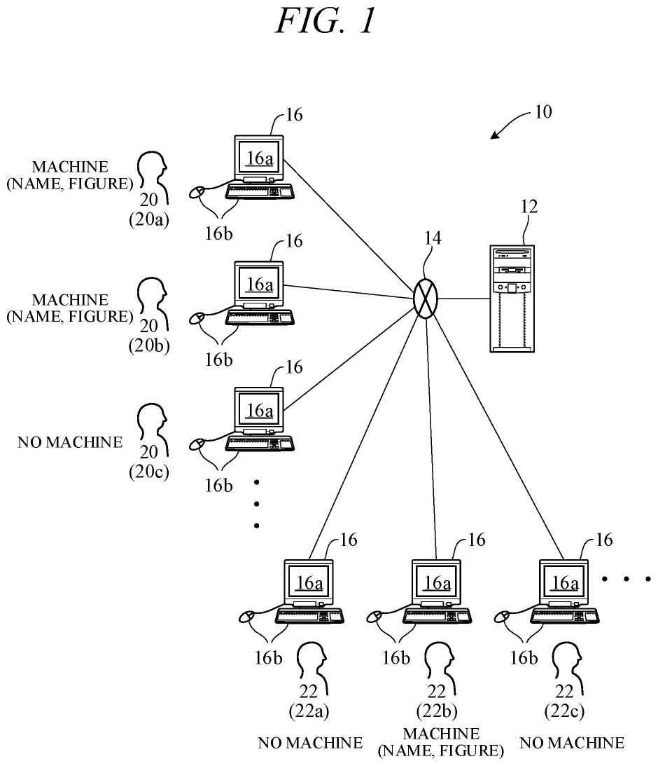

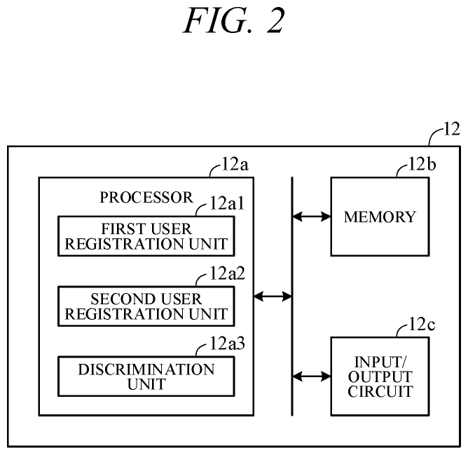

FIG. 1 is a conceptual diagram showing an overview of a capability matching assist apparatus according to an embodiment of this invention and FIG. 2 is an explanatory diagram detailing the configuration of a computer of FIG. 1.

In FIG. 1, reference numeral 10 indicates a capability matching assist apparatus (hereinafter called “assist apparatus”). The assist apparatus 10 comprises a single computer 12 connected through a network 14 to be capable of accessing multiple computers 16.

The computers 16 are configured to be operable by at least one first user 20 capable of providing capability and at least one second user 22 needing capability. The first user(s) 20 includes one or multiple persons 20a, 20b, 20c . . . and the second user(s) 22 includes one or multiple persons 22a, 22b, 22c . . . . The first user(s) 20 and second user(s) 22 are respectively a “person” defined as one among, inter alia, individual(s) (natural person(s)), juridical person(s) (profit-making and nonprofit corporation(s)), and community or group of individuals not having juridical personality.

The computer 12 is a large-scale computer with ample memory capacity, such as a server computer, mainframe computer or the like. As shown in FIG. 2, it is equipped with a processor 12a, memory 12b and input/output circuit 12c, and is installed at a suitable location (e.g., at residence of operator of the assist apparatus 10 or in a cloud environment). The computer 12 is not limited to a large-scale computer and can alternatively be a desktop personal computer, a laptop computer, a mobile computer, a PDA (Portable Data Assistant), a mobile phone or tablet terminal incorporating a program execution environment, or the like.

The network 14, which enables wired or wireless two-way data transmission between the computer 12 and computers 16, is the Internet or a LAN, public telephone network, company-internal network, service provider network, or the like.

Each of the computers 16 is a desktop personal computer, a laptop computer, a mobile computer, a PDA, a mobile phone or tablet terminal incorporating a program execution environment, or the like, and is equipped not only with a processor, memory and input/output circuit (none of which are illustrated) but also additionally with a display 16a and input equipment (keyboard, mouse and so on) 16b. The computers 16 are installed at the locations of the first user(s) 20 and second user(s) 22 and are configured to be operated by the “person” making up the first user(s) 20 and second user(s) 22.

The first user(s) 20 has human capability and/or machine capability. “Human capability” refers to skill, man power, interpersonal relationships (connections) and the like possessed by individual persons 20a, 20b, 20c . . . among the first user(s) 20 and specifically refers to their skill and labor-time availability. When the first user(s) 20 is a group such as a juridical person, “skill and labor-time availability” refers to skill and total labor-time availability of all members forming the group.

“Machine capability” refers to energy, power and the like produced by machine(s) owned by individual first user(s) 20 and specifically refers to value quantitatively expressing capability of such machine(s). For example, in the case of an electric generator and its portable power-source fuel, machine capability is the “rated output” of the generator, while in the case of a bulldozer it is “dirt quantity moved per cycle” and in the case of a high-pressure washer it is “maximum pressure, maximum water consumption.”

“Owned by” in the foregoing context indicates not only cases based on outright ownership, possessory right, lease right or other such legal right but also all other cases in which the machine is actually substantially under control of the first user(s). “Owned by” as termed here encompasses both “currently owned by” and “anticipated to be owned by in the future.”

As shown in FIG. 2, the processor 12a of the computer 12 comprises a first user registration unit 12a1 configured to register at least one of human capability of each first user 20 and machine capability of machinery owned by each first user 20 (register both when first user(s) 20 has both), a second user registration unit 12a2 configured to register at least one of human capability and machine capability needed by each second user 22 (register both when second user(s) 22 needs both), and a discrimination unit 12a3 configured to collate registered contents of the first user registration unit 12a1 and second user registration unit 12a2 and discriminate based on collation results whether second user(s) 22 can be benefited by providing capabilities of first user(s) 20. Specifically, the processor 12a of the computer 12 is configured to implement functions in the aforesaid manner by executing a program stored in the memory 12b.

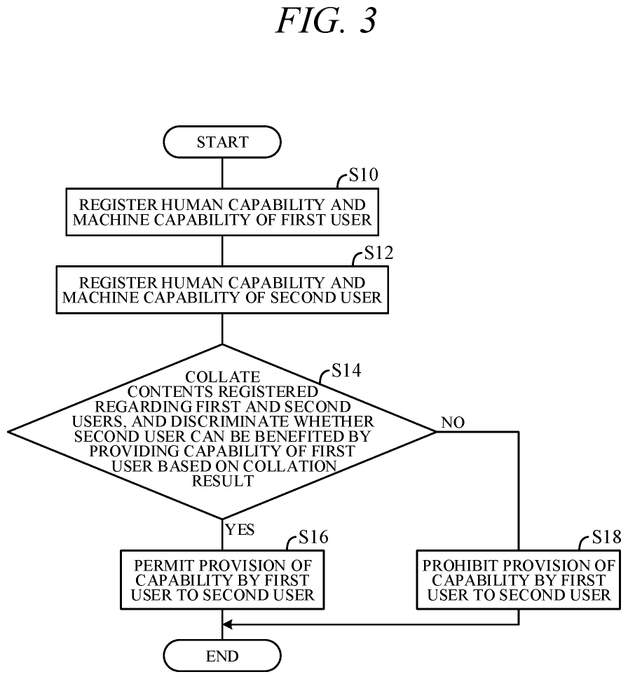

FIG. 3 is a flowchart showing operations performed by the assist apparatus 10, specifically the aforesaid functions performed by the processor 12a of the computer 12.

Now to explain, in S10 human capability(ies) such as labor-time availability and/or skills that first user(s) 20 can provide and machine capability(ies) such as those of generators and other machinery owned by first user(s) 20 are registered (S: processing Step of FIG. 3 flowchart). When the first user(s) 20 can provide only human capability or only machine capability, the providable capability is registered.

Matters registered at this time also include name, address (residence), machine location and other information regarding first user(s) 20 that second user(s) 22 requires to receive provided capability(ies). Moreover, when the machine of the first user(s) 20 is not a currently owned machine but a machine to be acquired in the future, expected date of machine acquisition is also registered.

As shown in FIG. 1, when the first user(s) 20 owns a machine, full or abbreviated name of the machine and a figure simply indicating is registered. Optionally, a colored figure can be registered.

Next, in S12, human capability(ies) and/or machine capability(ies) needed by the second user(s) 22 are registered. Although second user(s) 22 should by nature need only human capability(ies), both human capability(ies) and machine capability(ies) are registered at this time if machine capability(ies) has also been registered. The human capability(ies) is registered to include at least labor-time availability at place where needed by second user(s) 22 and skills needed and time frame of need by second user(s) 22.

The earlier explanation of “human capability(ies)” and “machine capability(ies)” with regard to first user(s) 20 also applies to the second user(s) 22. Moreover, matters registered at this time also include name, address (residence), machine location and other information regarding the second user(s) 22 that the first user(s) 20 requires to provide capability(ies). When the second user(s) 22 owns a machine, full or abbreviated name of the machine and a figure simply indicating is also registered. Optionally, a colored figure can be registered.

Next, in S14, content registered regarding first user(s) 20 and content registered regarding second user(s) 22 are collated and it is discriminated whether the second user(s) 22 can be benefited by providing capability(ies) of first user(s) 20 based on collation results.

At the time of this discrimination, it is discriminated whether human capability(ies) of first user(s) 20 can benefit the second user(s) 22 with consideration to, for example, labor time period or skills.

Moreover, in the case of multiple second users 22, some are selected and it is discriminated whether the first user(s) 20 can benefit the selected second user(s) 22 with consideration to time frame of needed capability(ies). To give a concrete example, when there are three second users (persons) 22, their order is provisionally decided based on time frame of needed capability(ies) and discrimination is performed taking into account, among other considerations, whether needs of the three second users 22 can be met in time in this order.

Whether the first user(s) 20 can contribute to the benefit of the second user(s) 22 is also discriminated in cases where capability(ies) that can be provided by first user(s) 20 do not fully meet capability needed by the second user(s) 22. Namely, when capability of a single first user 20 is insufficient, second, third and other additional first users 20 are sought until the needed capability is met, but when the needed capability still cannot be met, first users 20 are nevertheless discriminated to be capable of contributing to the benefit of second user(s) 22 on the thinking that what is available is better than nothing.

When the result in S14 is YES, the program goes to S16, in which provision of capability by first user(s) 20 to the second user(s) 22 is permitted.

As the discrimination unit 12a3 is also configured to calculate total accumulated capability that first user(s) 20 provides to the second user(s) 22, the discrimination of S14 additionally includes discrimination of whether total accumulated capability provided by first user(s) 20 has reached capability (upper limit value) needed by the second user(s) 22.

And when calculated accumulated capability is determined to have reached upper limit value, result of the discrimination in S14 is NO, and provision of capability by first user(s) 20 is determined to be unnecessary and the program goes to S18 in which provision of capability by first user(s) 20 to the second user (s) 22 is prohibited.

As set out in the foregoing, this embodiment is configured to have a capability matching assist apparatus (10) configured to assist matching of capability between at least one first user (20) who can provide capability and at least one second user (22) who needs capability, comprising a computer (12) equipped with at least one processor (12a) and at least one memory (12b) coupled to the processor, wherein the processor is configured to perform as a first user registration unit (12a) configured to register at least one of human capability of the first user(s) (20) and machine capability of machinery owned by the first user(s) (S10); a second user registration unit (12a2) configured to register at least one of human capability and machine capability needed by the second user (22) (S12); and a discrimination unit (12a3) configured to collate registered contents of the first user registration unit and second user registration unit and discriminate whether the second user is benefited by providing the capability of the first user based on collation results (S14-S18), which configuration enables suitable assistance of capability matching between person(s) who can provide capability and person(s) who needs capability. Moreover, if visualization of provider side and needer side capability registration by using characters and figures is carried out, it enables more suitable assistance.

Moreover, since it is configured such that the first user registration unit registers machine capability of machinery expected to be owned by the first user(s) in future (S10), capability of machinery anticipated to be owned in future can be taken into consideration in addition to machinery currently owned by the first user(s), thereby enabling still more suitable matching assistance. In addition, motivation of first user(s) to volunteer is enhanced.

Additionally, it is configuration such that the second user registration unit registers as the human capability at least one of labor time period at place needed by the second user(s) and skill needed by the second user(s) (22) (S12), and the discrimination unit discriminates with consideration to at least one of the labor time period and skill whether the human capability of the first user(s) can benefit the second user(s) (S14), thereby enabling even more suitable matching assistance based on a deeper grasp of the human capability.

Furthermore, it is configured such that the second user registration unit registers at least time frame needed by the second user(s) (22), and when the second user(s) includes multiple users (persons), the discrimination unit selects some of the second users and discriminates whether first user(s) benefits the selected second users (22) with consideration to time frame of needed capabilities (S14), so that the configuration makes it possible to enhance suitable and suitable matching assistance by reflecting priority of second user need of capability.

Moreover, it is configured such that the first user registration unit registers time frame when human capability and machine capability of the first user(s) can be provided, and the discrimination unit discriminates whether the first user(s) benefits the second user(s) with consideration to the provision-possible time frame (S14), which configuration makes it possible to enhance suitable matching assistance by reflecting provision-possible time frame of first user capabilities.

In addition, it is configured such that the discrimination unit discriminates that the first user(s) can contribute to the benefit of the second user(s) even when capability provided by the first user(s) do not fully meet capability needed by the second user(s) (S14-S16), so that, in addition to the aforesaid effects, such capabilities can, even though insufficient, nevertheless be provided to the second user as better than nothing.

Moreover, it is configured such that the discrimination unit calculates accumulated capability that the first user(s) provides to the second user(s), and when the total accumulated capability provided by the first user(s) reaches capability needed by the second user(s), discriminates that provision of capability of the first user(s) is unnecessary (is to be prohibited) (S14-S18), so that, in addition to the aforesaid effects, provision of unneeded capability can be minimized.

Further, it is configured such that the first user(s) (20) and the second user(s) (22) are one among individual (natural person), juridical person (profit-making or nonprofit corporation), and community or group of individuals not having juridical personality, thereby enabling suitable and reliable assistance of capability matching between person(s) who can provide capability and person(s) who needs capability.

While the foregoing states that registered contents of the first user(s) and second user(s) are collated and it is discriminated whether second user(s) can be benefited by providing capabilities of first user(s) based on collation results, the discrimination can optionally be performed by numerically calculating degree of contribution based on collation results.

Although background art of the present application was explained taking natural disasters and other emergency situations as examples, this is not intended to limit the scope of the present application and implementation with respect to all types of capability demand/supply matching situations is possible.

It should be note that any of the first user, the second person, the human capability and machine capability of the first user or second user can be single or plural in the number.

While the present invention has been described with reference to the preferred embodiments thereof, it will be understood, by those skilled in the art, that various changes and modifications may be made without departing from the scope of the appended claims.

What is claimed is:

1. A capability matching assist apparatus configured to assist matching of capability between at least one first user who can provide capability and at least one second user who needs capability, comprising:
a computer equipped with at least one processor and at least one memory coupled to the processor,
wherein the processor is configured to perform as
a first user registration unit configured to register at least one of human capability of the first user and machine capability of machinery owned by the first user;
a second user registration unit configured to register at least one of human capability and machine capability needed by the second user; and
a discrimination unit configured to collate registered contents of the first user registration unit and second user registration unit and discriminate based on collation results whether the second user can be benefited by providing the capability of the first user.

2. The apparatus according to claim 1, wherein the first user registration unit registers machine capability of machinery expected to be owned by the first user in future.

3. The apparatus according to claim 1, wherein the second user registration unit registers as the human capability at least one of labor time period at place needed by the second user and skill needed by the second user, and the discrimination unit discriminates with consideration to at least one of the labor time period and skill whether the human capability of the first user benefits the second user.

4. The apparatus according to claim 1, wherein the second user registration unit registers at least time frame needed by the second user, and when the second user includes multiple users, the discrimination unit selects some of the second users and discriminates whether the first benefits the selected second user with consideration to time frame of needed capabilities.

5. The apparatus according to claim 1, wherein the first user registration unit registers time frame when human capability and machine capability of the first user are to be provided, and the discrimination unit discriminates whether the first user benefits the second user with consideration to the provision-possible time frame.

6. The apparatus according to claim 1, wherein the discrimination unit discriminates that the first user contributes to the benefit of the second user even when capability provided by the first user do not fully meet capability needed by the second user.

7. The apparatus according to claim 1, wherein the discrimination unit calculates accumulated capability that the first user provides to the second user, and when the total accumulated capability provided by the first user reaches capability needed by the second user, discriminates that provision of capability of the first user is unnecessary.

8. The apparatus according to claim 1, wherein the first user and the second user are one among individual, juridical person, and community or group of individuals not having juridical personality.
